(19) United States
(12) Patent Application Publication
(10) Pub. No.: US 2022/0220753 A1
(43) Pub. Date: Jul. 14, 2022

(54) Prop Head For Formwork Shoring And Method Of Using Same

(71) Applicant: Shinwide Pty. Ltd., Fairy Meadow (AU)

(72) Inventor: Luis Araujo, Unanderra (AU)

(21) Appl. No.: 17/607,203

(22) PCT Filed: Apr. 29, 2020
(86) PCT No.: PCT/AU2020/050420

§ 371 Date: Oct. 28, 2021

(30) Foreign Application Priority Data
Apr. 29, 2019 (AU) 2019901447

(51) Int. Cl. E04G 11/48

(52) U.S. Cl. CPC E04G 11/483; E04G 11/56

(57) ABSTRACT

Disclosed is a prop head for connecting a formwork prop to an elevated concrete slab formwork waler table or the like; said waler table having a plurality of support beams having a cavity or gap space adapted to receive an upper part of said prop head, said table being adapted to receive a bolt across said gap or cavity; wherein said prop head has: a central plate having a front end, a rear end and two sides, said sides having downwardly projecting lower L-shape angle brackets therefrom, said brackets being adapted to receive the top of said prop in a horizontally sliding manner from said front end; a downwardly projecting stop wall from the rear end of said central plate, adapted to abut the upper part of said prop; an upper turret, rising from said lower plate, adapted to fit in said cavity or gap space; and having one or more laterally located slots or holes adapted to correspond with the position of complementary holes or slots in said support beams; and a hole or slot in said central plate adjacent said front end and adapted to receive a locking pin, bolt or wedge thereby to prevent said prop being removed from said brackets. Also disclosed is a method of first securely connecting the prop to a support beam of a waler table and subsequently sliding the T-shaped end of a prop into connection with the prop head and then securing with a locking member.

### TECHNICAL FIELD

The invention relates to the field of shoring equipment for concrete platform formwork. In particular, the invention relates to an improved shoring prop head and a method of installing same.

### BACKGROUND OF THE INVENTION

The construction of large modern buildings usually involves the pouring of elevated concrete slabs or beams. There are a wide variety of concrete formwork systems, depending on the style of the building and other prevailing conditions.

In some constructions, during pouring and setting of this concrete, such beams are formed from solid tables that form the ‘mould’ for the concrete. These tables are typically supported by a set of parallel cross joists. The joists are in turn supported by two or more waler beams that run perpendicular to the joists.

The waler beams will be supported by some form of shoring. This shoring may take the form of a relatively complicated cross braced formation. However, it may be preferred to support the waler beam with a set of simple height-adjustable props. An example of such a prop is that marketed by PERI GmbH of Weissenhorn Germany under the name ‘Multiprop’ and as illustrated in FIG. 1. An advantage of these type of props is that they are readily height adjustable, easy to transport and can be simpler to install than more complicated shoring.

What is required is a prop head that can connect the top of the prop to the underside of the waler beams. Such prop heads are available, but those on the market tend to suffer from one or more disadvantages. An example of the type of prop head that is available is the PERI Variodeck Swivel Head. This type of prop head performs the main function of effectively connecting the prop to the waler beam.

However, one disadvantage arises from the fact that these types of prop heads are complicated and bulky. This makes these heads more expensive to make.

Also, the bulky and complicated nature of such heads makes them more difficult to install on-site, which slows down other on-site operations and may increase the cost of such systems owing to greater manual operator hours to install these heads. They also potentially increase the risk of a lifting injury to the installer, particularly back injuries.

It also tends to be more difficult and/or more costly to transport such heads due to their weight and bulk.

Accordingly, it is an object of the invention to provide a prop head that ameliorates at least some of the disadvantages associated with the prior art.

### SUMMARY OF THE INVENTION

According to a first aspect of the invention, there is provided a prop head for connecting a formwork prop to a concrete slab formwork waler table or the like; said waler table having a plurality of support beams having a cavity or gap space adapted to receive an upper part of said prop head, said table being adapted to receive a bolt across said gap or cavity; wherein said prop head has:

a central plate having a front end, a rear end and two sides, said sides having downwardly projecting lower brackets therefrom, said brackets being adapted to receive the top of said prop in a horizontally sliding manner from said front end;

a downwardly projecting stop wall from the rear end of said central plate, adapted to abut the upper part of said prop;

an upper turret, rising from said lower plate, adapted to fit in said cavity or gap space; and having one or more laterally located slots or holes adapted to correspond with the position of complementary holes or slots in said support beams; and

a hole or slot in said central plate adjacent said front end and adapted to receive a locking pin, bolt or wedge thereby to prevent said prop being removed from said brackets.

This configuration delivers a prop head that is lighter and smaller without sacrificing performance in securing the prop to the waler beam. This in turn allows the prop head to be pre-installed and secured to the prop off-site and transported efficiently to the site. This then allows the props to be installed in a shorter time and with reduced labour requirement on-site.

Also, the invention facilitates the installation of the prop without the requirement for working at heights. The installation can be done, with Installers standing on an existing concrete slab or firm ground. This will reduce the risk of work place injuries due to falls from heights.

During installation, the top of the prop simply slides into the receptacle area bounded by the two lower-extending brackets, the rear stop and the central plate, and is then locked in place by inserting a locking pin or wedge into the hole.

Preferably, there are located two spaced apart vertical guide plates or the like above said hole adapted to receive a locking wedge therebetween. This allows for a quicker and more secure installation of the locking wedge.

More preferably, said locking wedge is formed from steel plate and has a wider and narrower end; and wherein there is a stop piece attached to said wider end; and wherein said stop piece is wider than the space between said guide plates or the like. A locking wedge having this configuration can be installed and secured more rapidly and with better precision.

Preferably, said turret is constructed from two lengths of rectangular hollow section (RHS) tube steel arranged adjacent one another and stood vertically on said central plate, each said tube having at least one cross drilled bolt hole through said tube. This arrangement is strong and relatively lighter and cheaper to construct.

Further, a prop head according to the invention requires a much simpler fabrication process compared with prior art prop heads.

According to another aspect of the invention, there is provided a method of connecting a formwork prop to a concrete slab formwork waler table or the like; said waler table having a plurality of support beams having a cavity or gap space adapted to receive an upper part of a prop head and a plurality of bolt holes adapted to receive a bolt across said gap or cavity; said method including in any order the steps of: inserting the upper turret of a prop head according to claim 1 into said gap or cavity; securing said prop head by inserting suitable bolts through said bolt holes in said beams and said turret; sliding the top of said prop into said prop head below said central plate; inserting a locking bolt, wedge or pin into said hole thereby to secure said prop in said prop head.

This method, enabled by the present invention, is a simpler and quicker way to install a prop under a waler beam in a concrete formwork construction.

Now will be described, by way of a specific, non-limiting example, a preferred embodiment of the invention with reference to the drawings.

### BRIEF DESCRIPTION OF THE DRAWINGS

FIG. 1 is a drawing of a PERI Multiprop formwork prop of the type that is compatible with the invention.

FIG. 2 is a drawing of a formwork table installation of a type with which the invention may be used.

FIG. 3 is a lateral view of a prop head according to the invention.

FIG. 4 is a front view of a prop head according to the invention.

FIG. 5 is a plan view of a prop head according to the invention.

FIG. 6 shows lateral, front and top views of a locking wedge according to the invention.

FIG. 7 shows a lateral view of a prop head according to the invention installed on a prop according to FIG. 1.

### DETAILED DESCRIPTION OF THE INVENTION

A particular type of formwork shoring for pouring of concrete slabs involves the support of a formwork table on a set of crossbeams. The cross beams are in turn supported by two or more laterally arranged waler beams. The waler beams are supported by props and are secured to the props via a prop head.

Waler beams often take the form of a ‘split’ beam, where there are two parallel members arranged with a gap between them.

The invention may be characterised as a conception of a prop head design that is relatively simple and light, but which successfully secures an upper part of a prop to the underside of a waler beam.

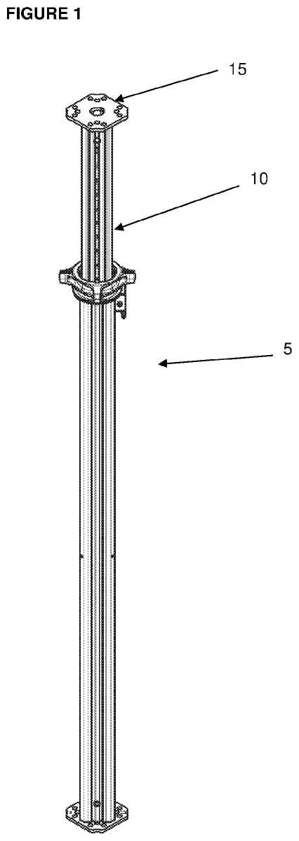

Turning to FIG. 1, there is shown a prop of the type described above. This particular prop is an example of a PERI Multiprop MP 350 prop as supplied by PERI GmbH of Weissenhorn Germany. The prop 5 has an extendable stem 10 and a platform 15. The platform 15 is a steel plate of approximately 150 mm×150 mm. In the description below, this type of prop will be used as an example of the type of prop that the present invention can be used in conjunction with. However, those skilled in the art will understand that the inventive concept is not limited to this one type of prop and that the concept may be extended to a variety of other prop designs.

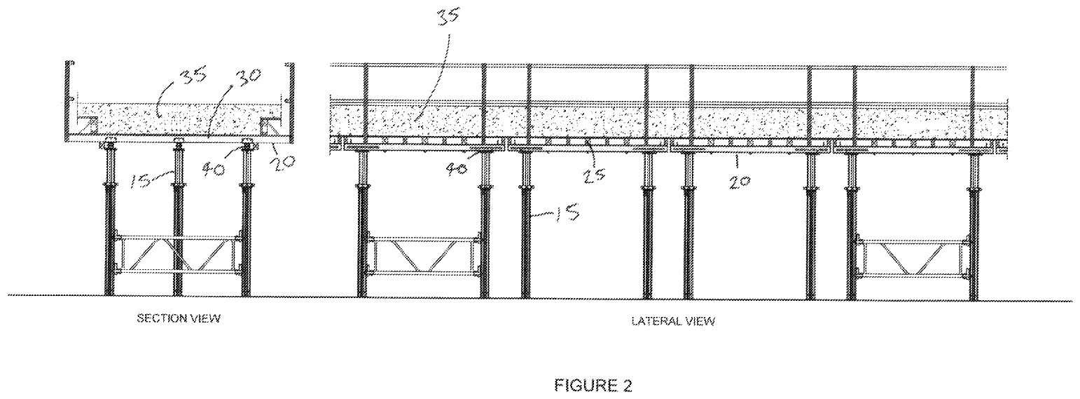

Turning to FIG. 2, there can be seen an elevated formwork system incorporating such props. Several props 15 are shown connected to one or more waler beams 20. Across the waler beams 20 are laid several crossbeams 25. The cross beams 25 in turn support the formwork table 30, upon which the concrete 35 is poured. The prop heads 40 are located at the top of the props 15, where they are connected to the waler beams 20.

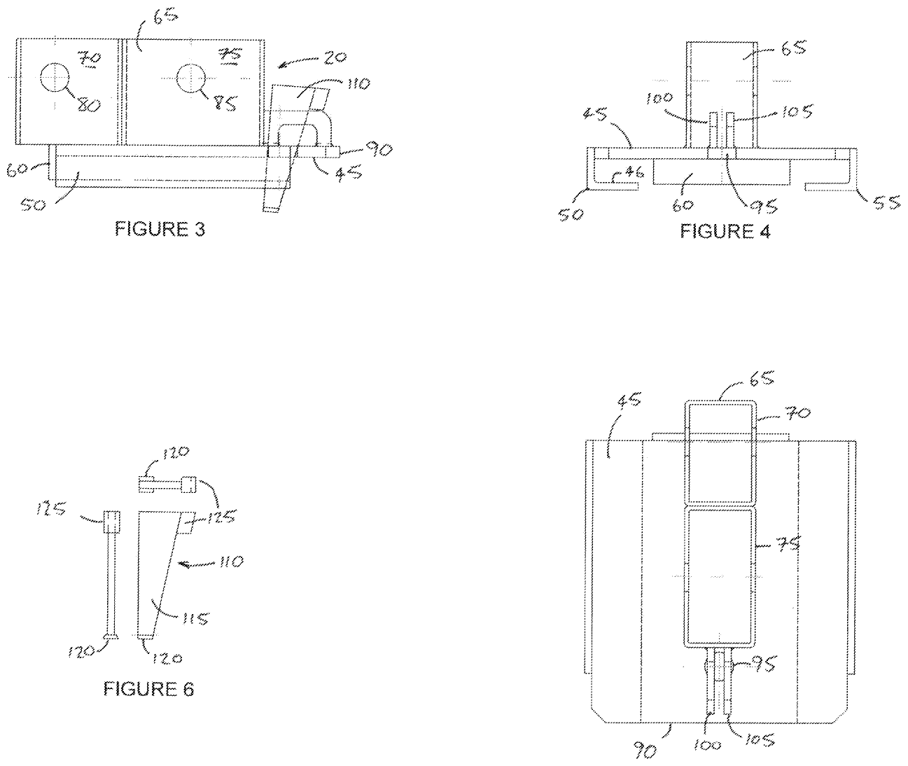

Turning to FIGS. 3, 4 and 5 there are shown three views of a prop head according to the invention. The prop head 20 is constructed in mild steel (or any other suitable material). It has a central plate 45 that is around 8 mm thick. Attached to each of the left and right sides of the plate 45 are lower brackets (50, 55) that extend downward from the length of the central plate 45 for about 30 mm, and fold or curl underneath the central plate 45 forming a ‘shelf’ lip 46 about 40 mm wide. These brackets may be formed from 5 mm right-angle steel rods and may be welded to the sides of the central plate 45.

There is a stop bar 60 that extends downward for about 20-30 mm from the rear end of the central plate 45. This may be made from 5 mm steel plate welded to central plate 45.

On top of the central plate 45 is located an upper turret 65 that is designed to fit into the gap of the waler beam. As shown, this may be formed from two pieces of rectangular cross section steel tube (70, 75), approximately 75 mm long and 50 mm wide, welded side-by-side to the top of the central plate 45. Through each tube part are cross-drilled bolt holes (80, 85) of approximately 20 mm diameter. The distance between the bolt hole centres is chosen to correspond to the distance between the complementary holes on the waler beam.

Adjacent the front edge 90 of the central plate 45 is a locking hole 95, of about 20 mm diameter, drilled through the plate. Above the locking hole are arranged two locking brackets (100, 105) that are welded in place. They are spaced apart by about 6-7 mm.

As shown in FIG. 3, the locking wedge 110 is adapted to be removably inserted between the locking brackets (100, 105) and into the locking hole 95.

Turning to FIG. 6, the locking wedge 110 is shown in more detail. It consists of a roughly triangular 115 body made from flat plate steel, with a lower stop piece 120 located at the narrower end of the wedge, which is wider than the wedge body 115. There is also an upper stop piece 125 located on one side of the wider end of the wedge, which is also wider than the wedge body.

As illustrated in FIG. 3, the wedge 110 is fitted into the locking hole 95 and between the locking brackets (100, 105). The lower stop piece 120 prevents the complete removal of the locking wedge 110 from said brackets, as its width prevents it passing between the gap therebetween.

The upper stop piece 125 prevents the wedge 110 from passing downward between the locking brackets (100, 105) as it is also wider than the gap between said brackets.

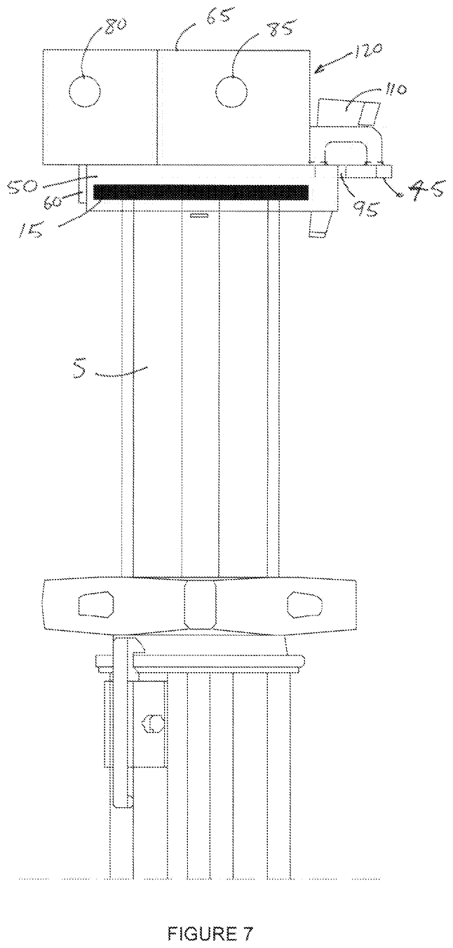

Turning to FIG. 7, there is shown a lateral view of a prop head 20 installed on the top of a prop 5. The upper platform 15 of the prop can be seen having been received (by sliding inwards) below the central plate 45, and secured by the lower brackets (50, 55) on each side, by the rear stop bar 60 at the rear and by the locking wedge 110 inserted through the locking hole 95.

This assembly may be undertaken off-site and the prop and head installation may then be transported in bulk to the site. The smaller size and weight of this assembly compared with the prior art makes this type of off-site assembly more feasible because it reduced size and weight makes bulk transport much simpler.

On site, the assembly described above can be installed by inserting the upper turret of the prop head into the waler beam gap and securing with two cross-bolts.

It will be appreciated by those skilled in the art that the above described embodiment is merely one example of how the inventive concept can be implemented. It will be understood that other embodiments may be conceived that, while differing in their detail, nevertheless fall within the same inventive concept and represent the same invention.

1. A prop head for connecting a formwork prop to a concrete slab formwork waler table or the like; said waler table having a plurality of support beams having a cavity or gap space adapted to receive an upper part of said prop head, said table being adapted to receive a bolt across said gap or cavity; wherein said prop head has:
a central plate having a front end, a rear end and two sides, said sides having downwardly projecting lower brackets therefrom, said brackets being adapted to receive the top of said prop in a horizontally sliding manner from said front end;
a downwardly projecting stop wall from the rear end of said central plate, adapted to abut the upper part of said prop;
an upper turret, rising from said lower plate, adapted to fit in said cavity or gap space;
and having one or more laterally located slots or holes adapted to correspond with the position of complementary holes or slots in said support beams; and
a hole or slot in said central plate adjacent said front end and adapted to receive a locking pin, bolt or wedge thereby to prevent said prop being removed from said brackets.

2. The prop head of claim 1, wherein there are located two spaced apart vertical guide plates or the like above said hole adapted to receive a locking wedge therebetween.

3. The prop head of claim 2, wherein said locking wedge is formed from steel plate and has a wider and narrower end; and wherein there is a stop piece attached to said wider end; and wherein said stop piece is wider than the space between said guide plates or the like.

4. The prop head of claim 1, wherein said turret is constructed from two lengths of rectangular hollow section (RHS) tube steel arranged adjacent one another and stood vertically on said central plate, each said tube having at least one cross drilled bolt hole through said tube.

5. A method of connecting a formwork prop to a concrete slab formwork waler table or the like; said waler table having a plurality of support beams having a cavity or gap space adapted to receive an upper part of a prop head and a plurality of bolt holes adapted to receive a bolt across said gap or cavity; said method including in any order the steps of:
inserting the upper turret of a prop head according to claim 1 into said gap or cavity;
securing said prop head by inserting suitable bolts through said bolt holes in said beams and said turret;
sliding the top of said prop into said prop head below said central plate;
inserting a locking bolt, wedge or pin into said hole thereby to secure said prop in said prop head.
